(19) United States
(12) Patent Application Publication
(10) Pub. No.: US 2018/0238543 A1
(43) Pub. Date: Aug. 23, 2018

(54) SAND BED DOWNDRAFT FURNACE AND ACTIVATED CARBON SCRUBBER

(71) Applicant: Kappes, Cassiday & Associates, Reno, NV (US)

(72) Inventors: Daniel W. Kappes, Reno, NV (US); Dustin J. Albin, Reno, NV (US); Donald W. Stewart, JR., Reno, NV (US)

(73) Assignee: Kappes, Cassiday & Associates, Reno, NV (US)

(21) Appl. No.: 15/440,913

(22) Filed: Feb. 23, 2017

(51) Int. Cl. F23J 15/04; B01D 53/14; B01D 53/64; B01D 53/00; B01D 45/16; F23N 1/00; F27B 3/28; F27B 3/20

(52) U.S. Cl. CPC F23J 15/04; B01D 53/1493; B01D 53/64; B01D 53/002; B01D 2252/103; F23N 1/002; F27B 3/28; F27B 3/205; B01D 2257/602; B01D 45/16

(57) ABSTRACT

A downflow hearth furnace includes a refractory-lined furnace lid. A burner is thermally coupled through the lid. A combustible material conveyor system communicates with an entry port. A variable speed motor driven rotatable combustible material disperser is positioned under the entry port and coupled to a rotation shaft. A refractory-lined furnace shell has a top edge mating with a bottom edge of the furnace lid and can be raised and lowered between an open position and a closed position. A bed of gas-permeable heat resistant material suspended on a layer of filter material defines a bottom end of a hearth disposed above a plenum. An outlet duct communicates with the plenum and has a horizontal outlet flange. A fixed scrubber input duct has an inlet flange positioned to mate with and form a seal with the outlet duct flange when the furnace shell is in the closed position.

### BACKGROUND

The present invention relates to industrial processes involving the use of activated carbon. More particularly, the present invention relates to methods and apparatus for incinerating activated carbon and scrubbing the exhaust gases.

Activated carbon is widely used in the chemical process industry to absorb hazardous materials. In gold mining, activated carbon is used to absorb gold out of a cyanide solution. During this process, gold-containing carbon fines are created and cannot be recycled into the process. It can be economically advantageous to recover the gold from the used carbon fines. In addition, the gold-process recovered carbon fines in many cases contain mercury, which presents environmental problems when attempting to extract the gold. Many gold mines simply stockpile the used carbon fines, which are later shipped to refineries to recover the gold. Transportation costs and environmental issues can make extraction of the gold uneconomical.

In addition, power plants are also turning to adsorption to process exhaust containing hazardous materials. Activated carbon and other adsorbents are being used to capture mercury in these industries. New regulations in the United States are forcing power plants to reduce mercury by 90%. The injection of activated carbon is the route many operators will take. This application of activated carbon requires an increasingly large volume of this material. According to some estimates, the market for activated carbon in the United States will effectively double. According to one source, annual industrial adsorption revenue in NAFTA is about $235 MM per year. In east Asia, the fastest growing region, it is about $430 MM/yr.

One of the problems with activated carbon is that it ends up being converted to fly ash, much of which is sold for use as a component in cement. The carbon, however, decreases cement strength. One solution for this has been the development of “cement friendly” activated carbon materials. If the activated carbon has been used to absorb mercury, a solution has to be found for removing the mercury before the carbon is incorporated into cement.

### BRIEF DESCRIPTION

According to one aspect of the present invention, a downflow hearth furnace with a sacrificial or partially replaced bed of gas-permeable material on the hearth to facilitate removal of the final roasted product and/or to maintain the bed in optimal permeable condition even when it is partially degraded by the roasting reactions. The bed may be formed from silica sand or some other naturally occurring or man-made material that can withstand the temperature of the roasting reaction and will remain inert and not oxidized by the roaster gases. Such materials include, but are not limited to, various classes of naturally occurring rocks composed of silicates, aluminates, or alkaline earth oxides, and man-made materials such as ceramics or refractories. The bed of gas-permeable material is selected to possess filtering characteristics that prevent the movement of the fine ash (solids combustion products) from their initial location above the bed. The bed is supported by a layer of gas-permeable filter material that blocks passage of bed material particles. The bed and filter material are supported by a structure formed from a material that can withstand the combustion temperatures produced in the furnace. Negative pressure pulls gaseous combustion products through the bed and out of the furnace below the layer of filter material.

A body portion of the furnace includes the bed and filter material. A lid for the furnace is suspended above the body portion at a rest position. The body portion of the furnace may be moved laterally from a position clear of the outer periphery of the lid to a position directly under the lid. The body portion of the furnace is lifted vertically until it engages the lid, which is free to move upwardly to provide a seal with the body portion. An annular gasket is disposed at an upper surface of the furnace body.

An exhaust duct that is coupled to a source of negative pressure pulls the gaseous combustion materials out of the furnace body extends upwardly and terminates in a horizontally-oriented gasketed flange. As the furnace body is raised to mate with the lid, the gasketed flange engages a mating flange disposed at a fixed unmoveable vertical position. The vertical position at which the mating flange is disposed at a position that is selected to be higher than the rest position of the furnace lid so that weight of the lid has already engaged and sealed the lid to the furnace body at a vertical position below which the gasketed flange engages the mating flange. The vertical position of the mating flange is selected in conjunction with the height to which the furnace body is raised so that a seal sufficient to prevent leaks from the ambient atmosphere from decreasing the negative pressure that is pulling the gaseous combustion products through the system.

To operate the furnace, the furnace bed is moved laterally to a position where it will engage the furnace lid and is then lifted to engage the furnace lid and place the gasketed flange in contact with the mating flange. The carbon is introduced into the furnace and ignited. After ignition, the rate at which the carbon is introduced into the furnace is controlled to maintain a constant temperature of the region of the furnace where combustion is taking place. As the carbon enters the furnace it is evenly dispersed across the bed to promote even combustion and to prevent the formation of bypass regions to provide an even pressure differential over the entire area of the furnace between the combustion region above the bed and the region below the layer of filter material. The negative pressure pulling the gaseous combustion products through the system is monitored and the combustion is stopped by halting the feed of carbon when the pressure has increased to a preselected amount. The furnace body is then lowered and moved laterally away from the furnace lid.

According to one aspect of the invention, the furnace includes a refractory lined metal shell, which may be cylindrical or polygonal in shape, having an integral, non-permeable bottom and an open top and a removable refractory-lined or refractory lid having a set of holes designed to allow the entry of a flame generated by a burner inserted into the top of the lid, and to allow the entry of air to support reaction of the products. An insertable basket seals against the walls of the furnace to prevent excessive short circuiting of air around the basket, and the bottom of which consists of a screen or plenum with small holes to allow downward flow of gases. A replaceable layer of a permeable bed of sand or other material as elsewhere described, is located on the basket, to prevent the downward flow of solids. At least one outlet is formed through the side wall of the shell to allow for instrumentation and for the exhaust of the combustion gases from below the bed.

According to another aspect of the present invention, a device for the roasting of spent activated carbon, waste sludges, or other organic wastes includes at its head or feed end a furnace as just described, a first scrubber unit consisting of a closed tank of water, chemical solution, or other inorganic or organic liquid, with a venturi scrubber and a cyclone separator mounted on top of the tank such that the liquid effluents from the scrubber and separator will fall by gravity into the tank; and a connection from the furnace to the inlet of the venturi so that gases are sucked into the venturi then through the cyclone separator, and connections for introducing the scrubber (scrubbing) liquid and for removing excess liquid. The system includes a second scrubber unit essentially identical to the first scrubber unit, which will be operated under slightly different conditions or with a different chemical liquid to effectively remove objectionable impurities which may not have been removed in the first unit. The system may also include more absorber units as necessary to effect acceptable clean up of the gas stream for discharge to the atmosphere. An exhaust fan or blower sufficient to operate the system in an effective manner is employed to pull the gasses from the furnace and through the scrubber units.

The first unit may be operated with a moderate continuous flow of water or of process solution from elsewhere in the industrial complex, in order to lower the temperature of the process gas stream from the high temperature of combustion in the furnace to a temperature below about 350° C., and preferably below about 40° C. The second unit may be operated with a recycle stream of a cooling fluid such as cold brine which is cooled by an external chiller, such that the temperature of the process gas stream leaving this unit is low enough so that the vapor pressure of objectionable components is within the limits for atmospheric discharge of gases. The brine in the second unit is maintained at a lower temperature than the first unit, for example a temperature of between about −10° and about 0° C., with the object of controlling the vapor pressure of mercury in the gas stream. Where available “pregnant solution” (gold loaded cyanide solution) at a mine site can be used as a coolant.

A device according to the present invention may be employed for the control of mercury vapor discharge from any industrial process gas stream whereby the initial mercury level in the gas stream exceeds regulatory limits, which consists of an scrubber unit (venturi scrubber and cyclone separator mounted on a receiving tank), operating with a chilled brine stream at a temperature between about −30° and about +15° C., but preferably between about −10° and about +5° C., in such a manner that the brine is in intimate contact with the gas stream so that it simultaneously chills the gas stream and makes gas-liquid contact to remove mercury vapors to the regulatory limits. The brine may be a simple brine formulated to not freeze at the operating temperature, or it may be a more complex chemical brine which serves to chemically change and/or dissolve the mercury components for improved mercury removal.

The simple manually-operated furnace may be expanded to include multiple hearths such that the carbon can be fed continuously, for example, to center of the top hearth, slowly rabbled out, then back to center on a second hearth, then to the outside (to a discharge port) on a third hearth. Carbon will flow downward from hearth to hearth, gas will flow downward through the beds and out the bottom.

A removal mechanism for the manual furnace removes the ash layer with or without some of the permeable bed, using a scraper or a suction device. Bed material so removed can be cleaned and put back in the furnace, or sent with the ash for further processing. In one specific application, the purpose of ashing the carbon is to remove the carbonaceous components so that the carbon-free ash can be easily processed such as by leaching or smelting for recovery of its metal content, and the material in the permeable sand bed is silica sand or another material which is a normal component of the flux mixture used in the smelting of the ash.

### BRIEF DESCRIPTION OF THE DRAWING FIGURES

The invention will be explained in more detail in the following with reference to embodiments and to the drawing in which are shown:

FIG. 1A is a diagram showing an illustrative downdraft furnace that may be employed in accordance with the present invention, shown in an open position;

FIG. 1B is a diagram showing the downdraft furnace of FIG. 1A in a closed position;

FIGS. 2A and 2B are diagrams illustrating a downdraft furnace system employing more than one furnace body to increase system throughput.

FIG. 3 is a diagram showing an illustrative activated carbon scrubbing system in accordance with the present invention.

FIG. 4 is a flow diagram illustrating an illustrative process in accordance with the present invention.

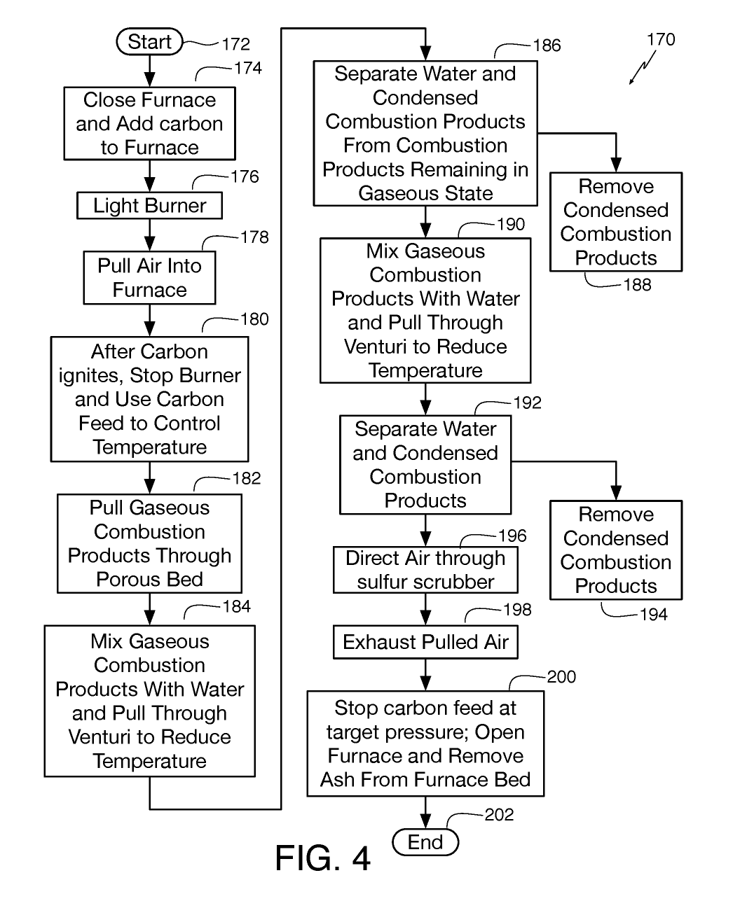

### DETAILED DESCRIPTION

Persons of ordinary skill in the art will realize that the following description of the present invention is illustrative only and not in any way limiting. Other embodiments of the invention will readily suggest themselves to such skilled persons.

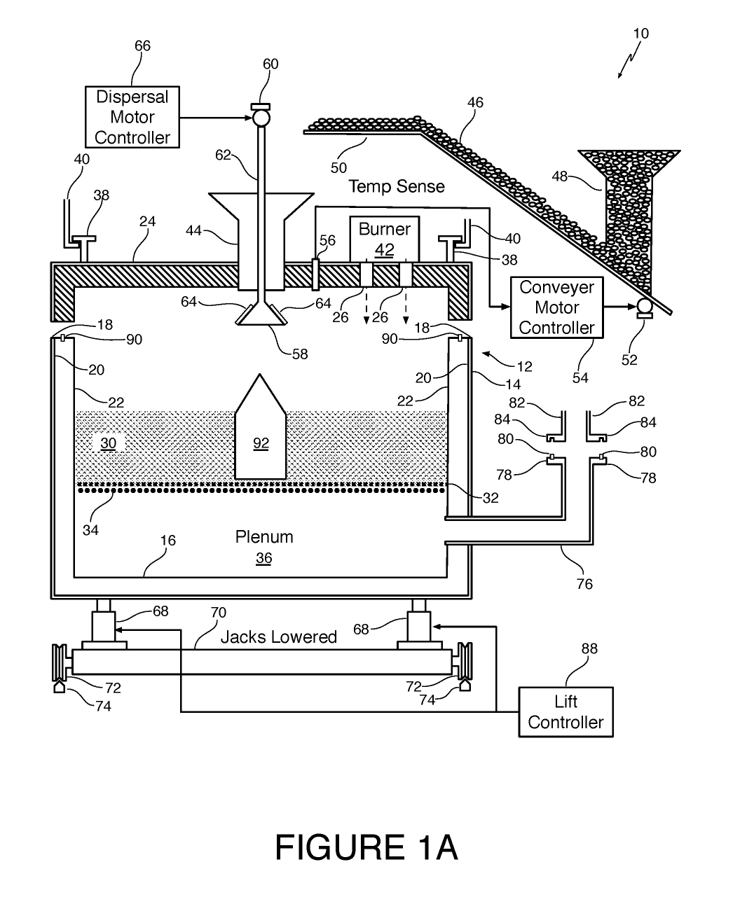

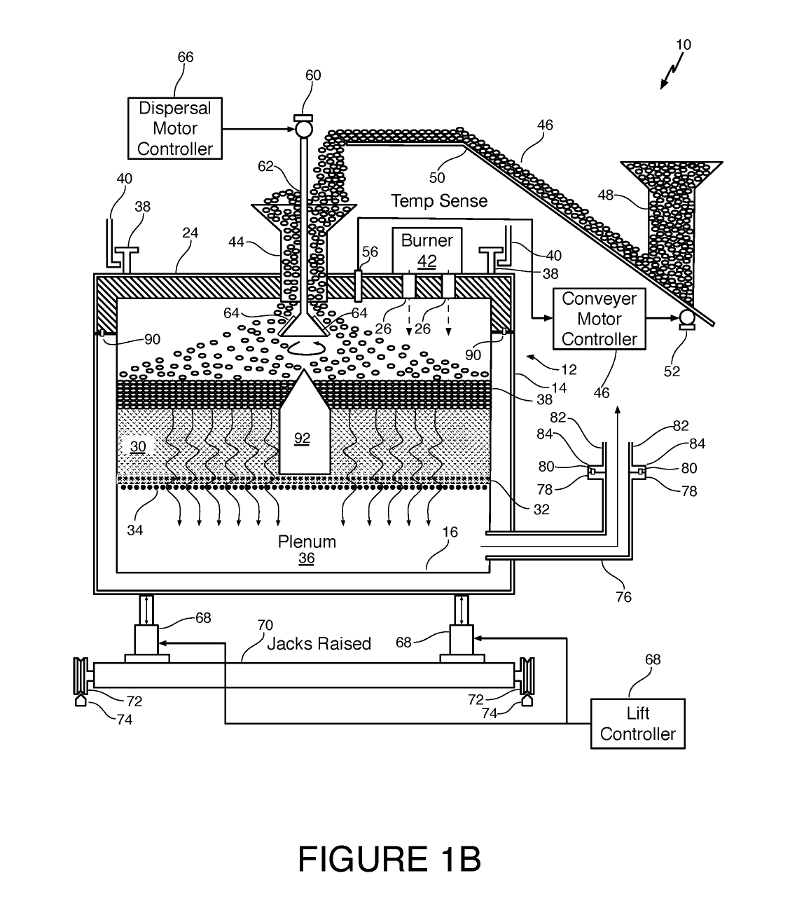

Referring first to FIG. 1A, a diagram shows an illustrative downdraft furnace 10 that may be employed in accordance with the present invention. Downdraft furnace 10 includes a furnace body 12 that is formed from a refractory lined metal shell 14 having an integral, non-permeable bottom 16 and an open top defined by upper ends 18 of vertical walls 20. The furnace body 12 is lined with a refractory material 22, formed from materials such as bricks, cement or mortar, or a ceramic material.

A removable refractory-lined or refractory lid 24 has a plurality of holes (two of which are designated with reference numeral 26) formed therein to allow entry of a flame generated by a burner 28 inserted into the top of the lid 24, and to allow the entry of air to support reaction of the products.

A sacrificial or partially replaced layer of gas-permeable bed material 30 is supported by a layer of gas-permeable filter material 32 that blocks passage of bed material particles. The bed may be formed from silica sand or some other naturally occurring or man-made material that can withstand the temperature of the roasting reaction and will remain inert and not oxidized by the roaster gases. Such materials include, but are not limited to, various classes of naturally occurring rocks composed of silicates, aluminates, or alkaline earth oxides, and man-made materials such as ceramics or refractories. In one illustrative embodiment of the present invention used to process activated carbon fines, the bed material may comprise layer of about 2 inches of #30 silica sand, although this thickness is not critical so long as it is large enough to contain the expected solid ash combustion products.

The bed and filter material are supported by a support structure 34 formed from a material that can withstand the combustion temperatures produced in the furnace. The bed material 30 has a granular size small enough to trap the ash solids that remain behind after combustion of the material being processed but larger than the interstitial spaces in the layer of gas-permeable filter material 32 to prevent the downward flow of solids through the layer of bed material 30. In FIG. 1A the support structure 34 may be, in a non-limiting example, in the form of a plurality of spaced-apart tungsten carbide rods 34 shown in end view. A plenum 36 is defined between the support structure 34 and the bottom 14 of the furnace body.

The refractory-lined or refractory lid 24 is suspended from supports 38 that are captured by support brackets 40 that are anchored to a support structure for the system (not shown). As previously noted, the lid 24 includes apertures 26 to conduct heat from burner 42 into the furnace 12 when it is closed as will be shown in FIG. 1B.

A loading chute 44 positioned in the center of the lid 24 communicates with furnace 12 through lid 24 through which material to combust 46 (usually in a granular form) is dispensed into furnace 12 from a loading reservoir 48 by a system such as conveyor belt 50. The conveyor belt 50 is driven from a motor 52 controlled by a conveyor motor controller 54. Conveyor motor controller 54 receives a signal from temperature sensor 56 communicating with furnace 12 through lid 24 that is used to control the speed of the conveyor 50, thus the controlling the rate of introduction of combustible material 46 into the furnace 12 to maintain the furnace 12 at a desired temperature. This feature of the invention is provided to control the combustion of the material 46 to prevent or control the extent of fusing of the bed material 30. For example where sand is used as the bed material 30, substances that are to later be extracted from the solid ash combustion product may be more easily extracted if they are not encapsulated in agglomerated fused bed material.

A disperser 58 inside furnace 12 under the loading chute 44 is rotated by a motor 60 coupled to disperser 58 by shaft 62 to evenly disperse the material to be combusted 46 over the bed material 30. According to one embodiment of the invention, the disperser 58 may be a cone shaped structure having a plurality of vertically oriented vanes or protrusions 64 on its outer surface to aid in dispersing the material 46.

A dispersal motor speed controller 66 varies the speed of motor 60 and thus the speed of disperser 58 to vary the distance that the entering combustible material 46 is thrown from the center of the surface of the bed material 30 to evenly disperse the material across the bed material 30 to achieve a uniform depth of the combustible material as it rests on the bed material 30. As will be readily understood by persons of ordinary skill in the art, the varying speed of the motor 60 will be determined in any particular case by the characteristics of the combustible material 46, including its mass and particle sizes.

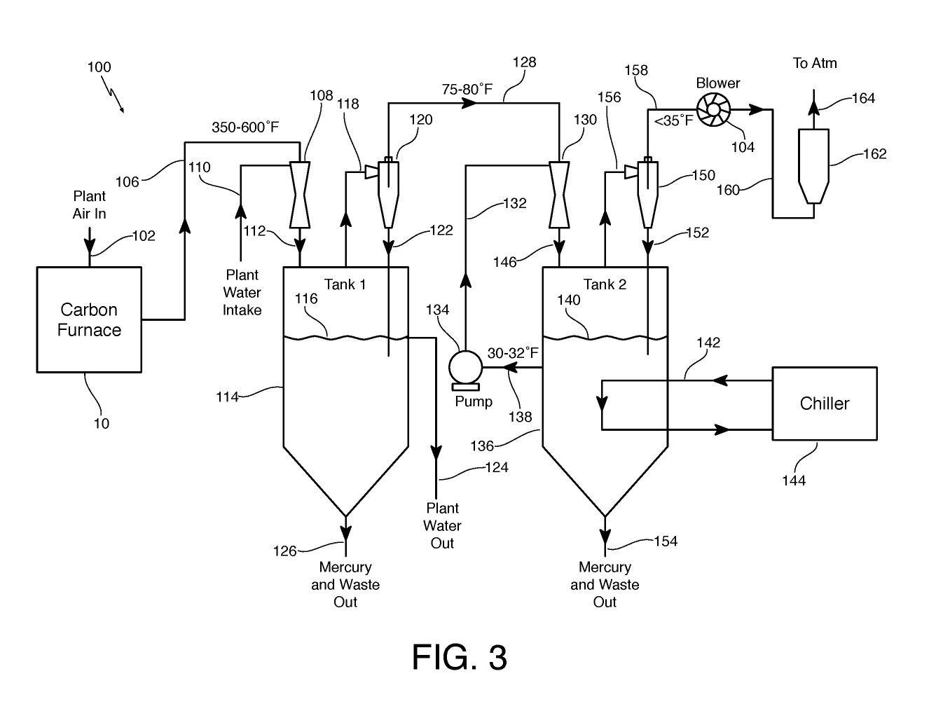

As illustrated in FIG. 1A, the furnace body 12 is coupled by jacks 68 to a support member 70. Jacks 68 can be, for example, hydraulic jacks or screw jacks. Wheels 72 are rotatably mounted to the support member 70 and ride on rails 74. A chain drive or other conveyance (not shown) may be used to control the lateral position of the furnace body 12 so that it may be laterally moved out from under the lid 24. In the particular embodiment shown in FIG. 1A, Persons of ordinary skill in the art will observe that the bottom of the disperser 58 is positioned to clear the tops 18 of the furnace walls. The rails 74 may be straight, allowing alternate use of two furnace bodies 12 with a single furnace lid 24 to increase the throughput of the system by allowing a furnace body 12 having fully combusted material to be moved away from the lid 24 and cooled while a second furnace body is placed into position for operation. In other embodiments, multiple furnace bodies 12 may be employed using circular rails or another carousel-type mechanism. This feature of the invention, illustrated in FIGS. 3A and 3B allows faster throughput for a system in accordance with one aspect of the present invention.

Negative operating pressure is applied to the plenum region 36 of the furnace body 12 through outlet duct 76. Outlet duct 76 terminates in a horizontally oriented flange 78. One or more annular gaskets 80 are disposed on the upper surface of flange 78 to seal the outlet duct 76 from the ambient atmosphere. A mating outlet duct 82 including a mating flange 84 that mates with flange 78 of output duct 76 is axially aligned with the vertical portion of output flange 78.

To operate the furnace 10, the furnace body 12 is laterally positioned under the furnace lid 24 and raised by jacks 68 using lift controller 88. Persons of ordinary skill in the art will appreciate that the configuration of lift controller will depend on the type of jacks 68 that are employed. FIG. 1B shows the furnace 10 in its operating position where the furnace body 12 has been raised into contact with the furnace lid 24. An annular gasket 90 helps provide a seal between the furnace body and the furnace lid 24. The gasket 90 is shown in the furnace body 12 but persons skilled in the art will appreciate that it could be connected to the lid 24. In addition, it may be seen that the flange 78 of outlet duct 76 is mated with and sealed against mating flange 84 of mating outlet duct 82. The extent to which jacks 68 may be raised is determined by the fixed location of mating flange 84 of mating outlet duct 82. This seal should be tight because it is desired to avoid ambient air leakage into the stream of gaseous combustion products being drawn from the plenum region 36 the furnace body.

In some embodiments where the geometry of the furnace system does not permit even dispersion of the material to be combusted 46 to extend under disperser 58, a central spacer 92 is shown in FIGS. 1A and 1B positioned below the disperser 58 to prevent an air pathway that bypasses the material to be combusted 46 and reduce the efficiency of the furnace. In the exemplary embodiment shown in FIGS. 1A and 1B, the spacer 92 is in the form of a cylindrical body having a generally cone-shaped top. Persons of ordinary skill in the art will appreciate that the size and shape of a spacer 92 in any particular embodiment will be determined by the configuration and size of the furnace, depth of the bed 30, as well as the size and other design and operating characteristics of the disperser 58.

After the lid 24 is mated to the furnace body 12 and the flanges 78 and 84 have been mated and sealed, combustible material 46 (e.g., carbon fines) is conveyed to the furnace 12 and distributed evenly across the bed material 30, and burner 42 is lit to ignite the combustible material 46. Negative pressure pulls gaseous combustion products through the bed and out of the furnace below the layer of filter material 32.

Persons of ordinary skill in the art will readily appreciate that materials other than activated carbon may be processed in the downdraft furnace 10 according to the teachings of the present invention. If activated carbon having sufficient carbon content is being processed, it will be able to exhibit self-sustained combustion and burner 42 may be turned off after the material has been ignited, after which temperature control is achieved by material feed rate as described above. Persons of ordinary skill in the art will appreciate that burner 42 may need to remain on during the combustion process where other materials are involved as a function of the nature of the particular material being combusted.

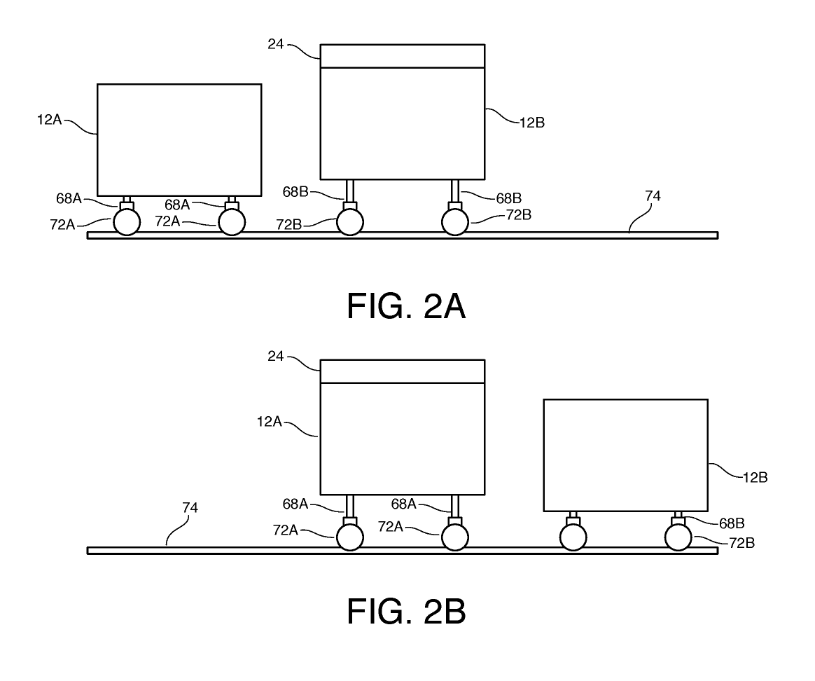

In accordance with another aspect of the present invention, some downdraft sand bed furnace systems may employ more than one furnace body to increase system throughput. An example of such a system is shown in FIGS. 2A and 2B.

In FIG. 2A, furnace body 12A is shown to the left side of the figure where it may be prepared for a burn cycle by, for example, replacing the sand bed material. Furnace body 12B is shown in its operative position with its jacks 68B raised to couple it to furnace lid 24. After the burn cycle in furnace bed 12B is completed, jacks 68B are lowered, furnace body is rolled along rails 74 to the position shown in FIG. 2B and furnace body 12 A is rolled along rails 74 to the position shown in FIG. 3B and jacks 68A are raised to couple to couple it to furnace lid 24, where its burn cycle may be initiated. A chain drive or other conveyance mechanism (not shown) may be used to reposition furnace bodies 12A and 12B as shown in FIGS. 2A and 2B. Persons of ordinary skill in the art will appreciate that other configurations, such as multiple furnace bottoms 12 positioned along a circular or other shaped loop are contemplated and may be employed in the present invention.

By employing a downdraft sand bed furnace system having multiple furnace bottoms 12 such as the one shown in FIGS. 2A and 2B, greater throughput may be achieved. One furnace bottom 12A or 12B may be coupled to furnace lid 24 and undergo a burn cycle while the other furnace bottom is decoupled from lid 24 and laterally moved away from lid 12 so it may be emptied and serviced for a next burn cycle.

Referring now to FIG. 3, a diagram shows an illustrative activated carbon scrubbing system 100 in accordance with the present invention. Persons of ordinary skill in the art will appreciate that, while the embodiment described with reference to FIG. 3 pertains to removal of mercury from activated carbon, the removal system disclosed can be employed to remove other substances from activated carbon as well as from other combustible substrate materials.

Carbon scrubbing system 90 includes downdraft bed furnace 10, which may be configured as shown in FIGS. 1A and 1B. The activated carbon material or other material to be scrubbed is placed in the furnace bed and ignited. Intake air, indicated at reference numeral 102, is pulled into the downdraft bed furnace 10 by blower 104. Gaseous combustion products from the downdraft bed furnace 10, which may be at a temperature of between about 350° to about 600° F. depending on the composition and fineness of the carbon and the composition of the non-combustible impurities, are pulled in pipe 106 to first venturi 108 where they are mixed with ambient temperature water from water intake 110 introduced circumferentially into the first venturi 108. First venturi 108 is configured to drop the temperature of the gasses from the high furnace exit temperature to a temperature in the range of about 75° to about 85° F. In one non-limiting example, first venturi 108 includes a straight section 4 inches in diameter and 8.5 inches long, linearly tapering to a diameter of 2 inches over a 5-inch distance, followed by another linearly expanding section expanding to a 4-inch diameter over a 5-inch distance. Design of a venturi for a desired temperature drop for a given gas flow and water flow rate is a matter of exercise of ordinary skill in the art.

The cooled gasses are delivered by pipe 112 to a first tank 114. First tank 114 is filled with the water exiting the first venturi 108 to a level indicated by reference numeral 116. The cooled gasses are drawn through pipe 118 and introduced circumferentially into first cyclone 120, where centrifugal force forces the finely-divided water component to collide with the outer wall and condense. The water is drawn back into the first tank 114 through pipe 122, which terminates at a point below the water level in the first tank 114. Outlet pipe 124 maintains the water level in first tank 114. Any condensed or solidified waste such as mercury may be removed from the first tank 114 through pipe 126.

The separated and cooled gaseous component is drawn up into pipe 128 which extends down into first cyclone 120 below its top end, and pulled into second venturi 130 where it is mixed with chilled water from pipe 132 pumped by pump 134 from second tank 136 through pipe 138. Second tank 136 is filled with water to a level indicated by reference numeral 140. The design of second venturi 130 is similar to that of first venturi 108. The water in second tank 136 is chilled by heat exchange coils 142 coupled to chiller 144. Chiller 144 is thermostatically controlled to maintain the water in the second tank 136 at a temperature of between about 30° to about 32° F. or as cold as 28° F. or less. Where the temperatures in the second tank 136 are close to the freezing temperature of water, the second tank 136 may use a fluid such as a brine solution that is compatible with the materials encountered in the process and that will remain in a liquid state at such temperatures. For example, a heat exchange liquid such as ethylene glycol may be employed. The temperature drop in the second venturi 120 is about 48° to about 50° F., and is sufficient to condense the mercury or other vapor fractions drawn from the downdraft furnace 10.

The cooled gasses are delivered to the second tank 136. Second tank 136 is filled with the water exiting the second venturi 130 through pipe 146. The cooled gasses are drawn through pipe 148 and introduced circumferentially into second cyclone 150, where centrifugal force forces the finely-divided water component to collide with the outer wall and condense. The water is drawn back into the second tank 136 through pipe 152 which terminates at a point below the water level in the second tank 136. Any remaining condensed or solidified waste such as mercury may be removed from the second tank 136 through pipe 154.

The exhaust air from second tank 136 is virtually free of combustion components and is drawn up into pipe 156 which extends down into second cyclone 150 below its top end, and is pulled through pipe 158 by blower 104. The exhaust air is then pushed through pipe 160 through sulfur scrubber 162 to remove all residual mercury from the system. The exhaust air is then vented into the atmosphere by vent pipe 164. In a typical embodiment of the invention, the exhaust air may be at a temperature of about 32°.

The entire system may be built in an integrated modular fashion, and can be made small enough to be shipped as an integral unit using commercial shipping container or flatrack equipment.

Referring now to FIG. 3, a flow diagram illustrating an illustrative process 170 in accordance with the present invention. In an exemplary embodiment, process 170 removes mercury from activated carbon, but, from the disclosure of the present invention, persons of ordinary skill in the art will understand that other substances can be removed from activated carbon or other combustible materials.

The process begins at reference numeral 172. At reference numeral 174, the furnace is closed and charged with activated carbon or other material from which substances are to be removed. At reference numeral 176 the activated carbon or other material is ignited and air is pulled into the furnace at reference numeral 178. At reference numeral 180 the burner is extinguished and the temperature of the furnace is maintained by controlling the flow of material into the furnace. With some materials, the burner may have to be maintained on or periodically turned on to maintain the temperature in the furnace.

At reference numeral 182, the gaseous combustion products are pulled through the porous furnace bed. At reference numeral 184, the gaseous combustion products are mixed with water and pulled through a venturi to reduce their temperature. At reference numeral 186, the water and condensed combustion products are separated from the combustion products remaining in the gaseous phase. At reference numeral 188, a process which may be performed periodically, the condensed combustion products are removed from the system.

At reference numeral 190, the remaining gaseous combustion products are mixed with water and pulled through a second venturi to further reduce their temperature. At reference numeral 192, the water and condensed combustion products are separated. At reference numeral 194, a process which may be performed periodically, the final condensed combustion products are removed from the system.

At reference numeral 196, the exhaust air is pulled from the system and may be vented to the atmosphere or further filtered if necessary. Reference numeral 198 shows the final combustion products being passed through a sulfur scrubber for further processing. The negative pressure in the system is constantly monitored. When the negative pressure exceeds a target level, indicating that the bed material 30 has become clogged, at reference numeral 200, the carbon feed is stopped, and the remaining carbon is allowed to burn out. The furnace is then opened and the ash is removed from the furnace bed. The process ends at reference numeral 202. Persons of ordinary skill in the art will appreciate that the process 170 may be restarted if, as previously noted, a second furnace bed 12 can be moved into position after the initial furnace bed is moved out from under the furnace lid 24 as previously shown in FIGS. 2A and 2B.

While embodiments and applications of this invention have been shown and described, it would be apparent to those skilled in the art that many more modifications than mentioned above are possible without departing from the inventive concepts herein. The invention, therefore, is not to be restricted except in the spirit of the appended claims.

What is claimed is:

1. A downflow hearth furnace comprising:
a refractory-lined furnace lid suspended in a stationary rest position;
a burner thermally coupled through the lid;
a combustible material entry port disposed in the lid;
a combustible material conveyor system communicating with the entry port;
a rotatable combustible material disperser positioned under the entry port and coupled to a rotation shaft;
a disperser motor coupled to the rotation shaft;
a variable speed motor drive circuit electrically coupled to the disperser motor.
a refractory-lined furnace shell having a top edge configured to mate with a bottom edge of the furnace lid;
a raising and lowering mechanism mechanically coupled to the furnace shell for moving the furnace shell between an open position where the furnace shell is clear of the furnace lid and a closed position where the furnace shell makes contact with the furnace lid;
a hearth disposed within the furnace shell;
a sacrificial or partially replaced bed of gas-permeable heat resistant material at a bottom end of the hearth suspended on a layer of filter material;
a plenum disposed below the hearth;
an outlet duct communicating with the plenum and having a horizontally disposed outlet flange;
a fixedly mounted scrubber input duct having a horizontally disposed inlet flange vertically positioned to mate and form a vacuum seal with the outlet flange of the outlet duct at when the furnace shell is raised to a position above which the furnace shell lid makes contact with the furnace lid.

2. The downflow hearth furnace of claim 1 wherein the bed is formed from a material that can withstand the temperature of the roasting reaction and will remain inert and not oxidized by the roaster gases.

3. The downflow hearth furnace of claim 2 wherein the bed is formed from one of silica sand and one of a naturally occurring rock material composed of silicates, aluminates, or alkaline earth oxides, and man-made materials including ceramics or refractories.

4. The downflow hearth furnace of claim 2 wherein the bed is formed from a substance that can be recovered from the final roasted product by magnetic separation means.

5. The downflow hearth furnace of claim 4 wherein the bed is formed from magnetite.

6. The downflow hearth furnace of claim 1 wherein the bed and the filter material rest on a support structure formed from a heat-resistant material.

7. The downflow hearth furnace of claim 6, wherein the heat resistant material comprises a plurality of spaced apart silicon carbide rods spanning the inner volume of the refractory-lined furnace shell.

8. The downflow hearth furnace of claim 1 wherein the bed comprises gas-permeable particles having average particle sizes selected to prevent the movement of fine ash solids combustion products from their initial location above the bed.

9. The downflow hearth furnace of claim 1 wherein the variable speed motor drive circuit is configured to control the speed of the disperser motor to disperse the combustible material to a substantially uniform depth across an upper surface of the bed.

10. The downflow hearth furnace of claim 1 wherein the rate at which the combustible material conveyor system conveys combustible material to the entry port is varied to control combustion to maintain a substantially constant temperature in the hearth furnace.

11. The downflow hearth furnace of claim 1 wherein the refractory-lined lid includes a plurality of holes formed therein to allow entry of a flame generated by the burner through the lid, and to allow the entry of air to support combustion of the combustion products.

12. The downflow hearth furnace of claim 10 further comprising:
a temperature sensor communicating with the furnace shell through the lid;
a motor coupled to the combustible material conveyor system;
a motor control circuit coupled to the temperature sensor to control the rate control combustion to maintain a substantially constant temperature in the hearth furnace.

13. The downflow hearth furnace of claim 10 further comprising:
a first scrubber unit fluidly coupled to the outlet duct and including a closed first tank of scrubber process solution, with a venturi scrubber and a cyclone separator coupled to the tank such that gases are sucked into the venturi then through the cyclone separator, the liquid effluents from the scrubber and separator falling by gravity into the first tank;
a second scrubber unit fluidly coupled to the first scrubber unit and including a second closed tank of scrubber liquid, with a venturi scrubber and a cyclone separator coupled to the second tank such that gases are sucked into the venturi then through the cyclone separator, the liquid effluents from the scrubber and separator falling by gravity into the second tank, the second scrubber unit configured to remove impurities not removed in the first unit; and
an exhaust fan or blower fluidly coupled to the second scrubber unit and configured to pull air into the furnace, through the first and second scrubber units.

14. The device of claim 13 wherein the first scrubber unit is operated with a continuous flow of process solution in order to lower the temperature of the process gas stream from the high temperature of combustion in the furnace to a temperature below 100 C.

15. The device of claim 14, wherein the first scrubber unit is operated with a continuous flow of process solution in order to lower the temperature of the process gas stream from the high temperature of combustion in the furnace to a temperature below 40 C.

16. The device of claim 13 wherein the process solution is selected from water, chemical solution, and other inorganic or organic liquid,

17. The device of claim 13, wherein the second scrubber unit is operated with a recycle stream of cold brine, such that the temperature of the process gas stream leaving the second unit is low enough so that the vapor pressure of components to be removed is within the limits for atmospheric discharge of gases.

18. The device of claim 17, wherein the brine is maintained at a temperature between −10 and 0 degrees C., thereby controlling the vapor pressure of mercury in the gas stream.

19. The device of claim 13 further comprising a sulfur scrubber coupled to the output of the second scrubber.
